(19) United States
(12) Patent Application Publication
(10) Pub. No.: US 2021/0131953 A1
(43) Pub. Date: May 6, 2021

(54) METHODS AND SYSTEMS FOR RAPID ANALYSIS OF CANNABINOIDS

(71) Applicant: University of Kentucky Research Foundation, Lexington, KY (US)

(72) Inventors: David Hildebrand, Lexington, KY (US); Julia Cassidy Wallin, Lexington, KY (US); Ju-Young Yoon, Lexington, KY (US)

(21) Appl. No.: 17/068,459

(22) Filed: Oct. 12, 2020

Related U.S. Application Data
(60) Provisional application No. 62/914,122, filed on Oct. 11, 2019.

(51) Int. Cl. G01N 21/33; G01N 1/38

(52) U.S. Cl. CPC G01N 21/33; G01N 2333/415; G01N 1/38

(57) ABSTRACT

A method for determining cannabinoid content in a hemp sample includes a providing a hemp sample including an amount of a cannabinoid, and subsequently transmitting an amount of light through the hemp sample, with the light having a wavelength of 225 nm or 235 nm. An optical density and/or an absorbance for the hemp sample is then identified and, based on the optical density and/or absorbance, the amount of cannabinoid in the sample is determined.

### RELATED APPLICATIONS

This application claims priority from U.S. Provisional Application Ser. No. 62/914,122, filed Oct. 11, 2020, the entire disclosure of which is incorporated herein by this reference.

### TECHNICAL FIELD

The presently-disclosed subject matter generally relates to methods and systems for the rapid analysis of cannabinoids from crude Cannabis extracts. In particular, certain embodiments of the presently-disclosed subject matter relate to methods and systems for the rapid analysis of cannabinoids whereby an amount of cannabinoids in a sample is measured based on the optical density and/or absorbance of the sample at a selected wavelength.

### BACKGROUND

There is a rapidly growing interest and correspondingly rapidly growing industry for the cultivation of Cannabis sativa, including industrial hemp, for the production of cannabinoids. Cannabinoids are the umbrella term for a group of mixed isoprenoid metabolites many of which contain phenolic moieties that hemp produces which gives them specific spectral properties and, in turn, allows their measurement as pure compounds. Indeed, Cannabis sativa L. has many cannabinoids of interest for health and medicinal uses. Among those of greatest interest are: cannabidiol (CBD), Δ9-tetrahydrocannabinol (THC), cannabichromene (CBC), and cannabinol (CBN), as well as the acidic form of cannabidiol (CBDA).

Various techniques have been used to quantify these cannabinoids, including: gas chromatography-flame ionization detection (GC-FID), high performance liquid chromatography (HPLC), and near infrared spectroscopy (NIRS). Previous studies have examined the spectroscopic characteristics of a number of cannabinoids including: Δ8-THC, Δ9-THC, CBD, CBN, cannabigerol (CBG), CBC, cannabicyclol (CBL), tetrahydrocannabivarin (THV) and their respective acidic counterparts. For instance, it is appreciated that a concentration of 0.01 mg/mL, CBDA has an absorbance of 4.50 at 222 nm, an absorbance of 3.88 at 258 nm, and an absorbance of 2.59 at 299 nm. It has also been shown that CBD at the same concentration has a peak at 207 nm with an absorbance of 4.57, another peak at 272 nm absorbing at 3.06, and a final peak at 280 nm with absorbance 3.05. Such prior studies, however, have been limited in that those studies depended on the wavelength range of the plate reader and on the use of wells which do not absorb short wavelengths.

Alternatively, other work has focused on various instruments for measuring cannabinoids and have made use of instruments which included a light source, an optical filter, and a means of collecting light either reflected, transmitted through, or a fluorescence of the material. Such studies have described the measurement of THC content in samples by deflecting light that has passed through the material or reflected off the material, where the measurements from the plate reader have light passing through an extract at every wavelength and where there is then an optical density that is specific to that sample. In short, such additional studies have focused on measuring the light produced, though, or reflected from a sample and then analyzing its entire spectra.

Another option for quantification of cannabinoids has been fluorescence. Cannabinoids have a phenol group which gives them a distinctive fluorescence in the correct excitation conditions. For example, in a further study, fluorescence at 576 nm was recorded in real time at the C18 media exit for 1 min during elution of fluorescing THC adduct, using 10 mW of 532 nm green laser light. A wavelength of 576 nm has also been used to establish a calibration curve and detect THC content in breath.

In each of the foregoing studies, however, pure cannabinoids are utilized, and thus the foregoing techniques are not directly useful for measuring cannabinoids as they are present within plants themselves. Accordingly, a method and system for analyzing cannabinoid content of both dry and wet hemp samples and that measures cannabinoid content within crude extracts of those samples would be both highly desirable and beneficial.

### SUMMARY

The presently-disclosed subject matter meets some or all of the above-identified needs, as will become evident to those of ordinary skill in the art after a study of information provided in this document.

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this Summary or not. To avoid excessive repetition, this Summary does not list or suggest all possible combinations of such features.

The presently-disclosed subject matter includes methods and systems for the rapid analysis of cannabinoids from crude Cannabis extracts. In particular, certain embodiments of the presently-disclosed subject matter include methods and systems for the rapid analysis of cannabinoids whereby an amount of cannabinoids in a sample is measured based on the optical density and/or absorbance of the sample at a selected wavelength.

In some embodiments of the presently-disclosed subject matter, a method for determining cannabinoid content in a hemp sample is provided. In some embodiments, an exemplary method for determining cannabinoid content in a hemp sample comprises an initial step of providing a hemp sample including an amount of a cannabinoid, and then transmitting an amount of light through the hemp sample, where the transmitted light has a wavelength of 225 nm or 235 nm. Upon transmitting the light through the sample, an optical density and/or an absorbance for the hemp sample is identified, and an amount of a cannabinoid in the sample is determined based on the optical density and/or absorbance.

In some embodiments, the hemp sample utilized in accordance with the presently-described methods is a dry hemp sample or a wet hemp sample. In some embodiments, the hemp sample is an intact hemp sample or a ground hemp sample. In some embodiments, the hemp sample is diluted in a solvent.

With respect to determining the amount of the cannabinoid in the sample, in some embodiments, determining the amount of the cannabinoid in the sample comprises determining the amount based on the optical density of the hemp sample. In some embodiments, determining the amount of the cannabinoid based on the optical density of the hemp sample comprises determining the amount using the following equations 1-5:

$$\begin{matrix}Blank corrected OD = Measured OD - Average OD of blanks ( well + EtOH + 0.05 mg / ml TBA ) & ( Eq . 1 ) \\ Calculated OD = Blank corrected OD * Dilution Factor & ( Eq . 2 ) \\ Fresh Weight ( FW ) CBD concentration ( \frac{mg}{mL} ) = 0.0493 * ( Calculated OD ) - 0.0058 & ( Eq . 3 ) \\ FW CBD concentration ( \% ) = FW CBD concentration ( \frac{mg}{mL} ) * \frac{vol . of solution ( mL )}{wt . of fresh sample ( mg )} * 100 & ( Eq . 4 ) \\ Dry weight CBD Concentration ( \% ) = \frac{FW CBD ( 5 )}{100 - moisture content} * 100 & ( Eq . 5 )\end{matrix}$$

In other embodiments of the methods and systems described herein, determining the amount of the cannabinoid in the sample comprises determining the amount based on the absorption of the hemp sample. In some such embodiments, determining the amount of the cannabinoid comprises determining the amount using the following equation: A=∈lc, where A is absorbance, ∈ is a molar extinction coefficient, l is a length of a light path, and c is the concentration of the cannbinoid in the sample.

With further respect to the determination of the amount of cannbinoid based on the optical density and/or absorbance of a hemp sample, in some embodiments, the wavelength of the light utilized is 235 nm. In other embodiments, the wavelength of the light utilized is 225 nm. In some embodiments, the optical density or absoprtion is measured using a microplate photometer. In some embodiments, the determination of the amount of the cannabinoid in the sample based on the identified optical density and/or absorbance is performed based on a comparison of the identified optical density and/or absorbance to a control amount.

Further features and advantages of the present invention will become evident to those of ordinary skill in the art after a study of the description, figures, and non-limiting examples in this document.

### BRIEF DESCRIPTION OF THE DRAWINGS

FIG. 1 is a graph showing a correlation between CBD content and Optical Density (OD) at 235 nm using 200 μL per well.

FIG. 2 is a graph showing a correlation between CBD content and OD at 272 nm using 200 μL per well.

FIG. 3 is a graph showing a correlation between CBD content and OD at 235 nm using 100 μL per well.

FIG. 4 is a graph showing a correlation between CBD content and OD at 235 nm using 100 μL per well.

FIG. 5 is a graph showing a correlation between CBD content and OD at 235 nm using 50 μL per well.

FIG. 6 is a graph showing a correlation between CBD content and OD at 235 nm using 50 μL per well.

FIG. 7 is a graph showing a scan of absorbance for 200 mg CBD/mL ethanol+tribenzylamine (TBA) showing saturated conditions.

FIG. 8 is a graph showing a scan of absorbance for 0.2 mg CBD/mL ethanol+TBA at partially saturated conditions.

FIG. 9 is a graph showing a scan of absorbance for standard 0.05 mg/mL TBA in ethanol at unsaturated conditions.

FIG. 10 is a graph showing peak OD 3.255 at 235 nm.

FIG. 11 is a graph showing peak OD 3.1025 at 236 nm.

FIG. 12A is a graph showing logarithmic fit of CBD dilutions versus the corresponding OD at 225 nm.

FIG. 12B is a graph showing linear fit of CBD dilutions with OD≤2 from FIG. 12A at 225 nm.

FIG. 13A is a graph showing logarithmic fit of CBD dilutions versus the corresponding Optical Density (OD) at 235 nm.

FIG. 13B is a graph showing linear fit of CBD dilutions with OD≤2 from FIG. 13A at 235 nm.

FIG. 14 is a graph showing linear fit of CBD dilutions versus the corresponding Optical Density at 255 nm.

FIG. 15 is a graph showing linear fit of CBD dilutions versus the corresponding Optical Density at 272 nm.

FIG. 16 is a graph showing logarithmic fit line of OD versus the CBD content of sample after addition of CBD in varying amounts.

FIG. 17 is a graph showing linear fit line of OD versus the CBD content of sample after addition of CBD in varying amounts.

FIG. 18 is a graph showing logarithmic fit of OD versus CBD content measured by GC of material in different stages of processing for CBD.

FIG. 19 is a graph showing linear fit of OD versus CBD content measured by GC of material in different stages of processing for CBD.

FIG. 20 is a graph showing logarithmic fit of OD versus CBD content measured by GC from dried, ground plant material.

FIG. 21 is a graph showing linear fit of OD versus CBD content measured by GC from dried, ground plant material.

FIG. 22 is a graph showing logarithmic fit of all standard samples for OD versus CBD content measured by GC.

FIG. 23 is a graph showing linear fit of all standard samples for OD versus CBD content measured by GC.

FIG. 24 is a graph showing linear fit of CBD concentration versus OD without any dilution of samples for 225 nm.

FIG. 25 is a graph showing linear fit of CBD concentration versus OD, diluting samples with concentrations 0.08-0.25 mg/mL and calculating OD from dilution factor of 1:5 at 225 nm.

FIG. 26 is a graph showing linear fit of CBD concentration without any dilution of samples for 235 nm.

FIG. 27 is a graph showing linear fit of CBD concentration versus OD, diluting samples with concentrations 0.15-0.25 mg/mL and calculating OD from dilution factor of 1:5 at 235 nm.

FIG. 28 is a graph showing linear fit of CBD concentration without any dilution of samples for 255 nm.

FIG. 29 is a graph showing linear fit of CBD concentration versus OD, diluting samples with concentrations of 0.08-0.25 mg/mL and calculating OD from dilution factor of 1:2 at 255 nm.

FIG. 30 is a graph showing linear fit of CBD concentration without any dilution of samples for 272 nm.

FIG. 31 is a graph showing linear fit of CBD concentration versus OD, diluting samples with concentrations of 0.08-0.25 mg/mL and calculating OD from dilution factor of 1:2 at 272 nm.

FIG. 32 is a graph showing correlation of CBD data from plate reader (225 nm, 235 nm, 255 nm and 272 nm) and CBD data from gas chromatography analysis of fresh hemp leaf and bud samples in Table 4.

FIG. 33 is a graph showing correlation of CBD data from plate reader (225 nm, 235 nm, 255 nm and 272 nm) and CBD data from gas chromatography analysis of dry hemp leaf and bud samples in Table 5.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, GenBank sequences, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

As used herein, the abbreviations for any protective groups, amino acids and other compounds, are, unless indicated otherwise, in accord with their common usage, recognized abbreviations, or the IUPAC-IUB Commission on Biochemical Nomenclature (see, Biochem. (1972) 11(9):1726-1732).

Although any methods, devices, and materials similar or equivalent to those described herein can be used in the practice or testing of the presently-disclosed subject matter, representative methods, devices, and materials are described herein.

The present application can “comprise” (open ended), “consist of” (closed ended), or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

The presently-disclosed subject matter is based, at least in part, on the discovery that amounts of cannabinoids, including cannabidiol (CBD) and its acidic form (CBDA), in crude plant extracts can readily be determined in plate readers with multi-well plates using wavelengths of 225 nm, 255 nm, 272 nm, and/or 235 nm. In this regard, and without wishing to be bound by any particular theory or mechanism, it is believed that the methods and systems described herein are capable of greatly increasing the efficiency and decreasing the cost associated with quantitating amounts of cannabinoids in plant samples when compared with standard techniques that make use of gas chromatography (GC) and high performance liquid chromatography (HPLC).

In some embodiments, a method for determining cannabinoid content in a hemp sample is thus provided. In some embodiments, a method for determining cannabinoid content in a hemp sample comprises an initial step of providing a hemp sample having or suspected of having an amount of a cannabinoid. In some embodiments, the hemp sample utilized may be a fresh or wet hemp sample, such as one that is obtained directly from a living plant, or may be a dry hemp sample, such as one that obtained from a living plant and then exposed to a drying process before analysis. Moreover, in some embodiments, the hemp sample may be one that is intact, meaning that the hemp sample has not undergone a significant amount of further processing, if any, subsequent to being obtained from the hemp plant, and such that the underlying plant structure of the sample is largely undamaged. In other embodiments, however, the hemp sample can be a ground hemp sample, whereby the hemp sample is reduced from a larger sample to a number of smaller particles. For example, in some embodiments, the hemp sample can be combined in a suitable container with a number of beads (e.g., glass or zirconium beads) and then processed using a commercially-available homogenizer (e.g., a “Bead Beater”) to disrupt the cellular structure of the hemp sample and reduce it to smaller portions.

Regardless of the particular hemp sample utilized, to determine the cannabinoid content of the sample, after providing the hemp sample, the sample is then placed in a suitable solvent, such as ethanol. That solution can then be centrifuged to remove cellular and other debris with the resulting supernatant being utilized for the measurement of optical density and absorbance. In some embodiments, the supernatant obtained through the processing of the hemp sample can be further diluted prior to such measurements.

With respect to the measurement of the optical density and/or the absorbance of the hemp sample and, in particular, the supernatant obtained through the processing of the hemp sample, various methods and devices known to those skilled in the art may be utilized including, but not limited to, spectrophotometers in various formats. In some embodiments, however, by making use the methods described herein, spectrophotometers in a micro-plate reader format can be utilized, whereby multi-well plates (e.g., 96 well plates) are used to process multiple samples in an efficient and effective manner. One exemplary microplate reader capable of being used in accordance with the presently-disclosed subject matter is the CLARIOSTAR® Microplate Reader produced by BMG Labtech, Inc. (Cary, NC).

To measure the optical density or absorbance of a sample in accordance with the presently-disclosed subject matter, an amount of light is subsequently transmitted through the sample (e.g., through a well of a multi-well plate including a sample of interest or through a cuvette depending on the format of the spectrophotometer) with the light having a particular wavelength. In this regard, in some embodiments of the presently-disclosed subject matter, the wavelength of light utilized is selected from 225 nm, 255 nm, 272 nm, and 235 nm. In certain embodiments, the wavelength of light utilized is 225 nm or 235 nm as both wavelengths of light have been surprisingly found to provide a good correlation between the optical density or absorbance measured and the amount of cannabinoid in a particular sample.

To determine the amount of a cannabinoid in a sample based on the optical density and/or absorbance of the sample, in some embodiments, it can be desirable to include a control sample (e.g., a blank or a control sample containing a known amount of a cannabinoid) that is analyzed concurrently with the hemp sample, such that the results obtained from the hemp sample can be compared to the results obtained from the control sample. Additionally, it is contemplated that standard curves can be provided, with which assay results for the hemp samples can be compared. Such standard curves present levels of cannabinoids as a function of assay units, i.e., optical density, if optical density is being measured.

In some embodiments of the presently-disclosed subject matter, determining the amount of the cannabinoid in the sample comprises determining the amount based on the optical density of the hemp sample. In some embodiments, determining the amount of the cannabinoid in the hemp sample comprises determining the amount using the following equations 1-5:

$$\begin{matrix}Blank corrected OD = Measured OD - Average OD of blanks ( well + EtOH + 0.05 mg / ml TBA ) & ( Eq . 1 ) \\ Calculated OD = Blank corrected OD * Dilution Factor & ( Eq . 2 ) \\ Fresh Weight ( FW ) CBD concentration ( \frac{mg}{mL} ) = 0.0493 * ( Calculated OD ) - 0.0058 & ( Eq . 3 ) \\ FW CBD concentration ( \% ) = FW CBD concentration ( \frac{mg}{mL} ) * \frac{vol . of solution ( mL )}{wt . of fresh sample ( mg )} * 100 & ( Eq . 4 ) \\ Dry weight CBD Concentration ( \% ) = \frac{FW CBD ( 5 )}{100 - moisture content} * 100 & ( Eq . 5 )\end{matrix}$$

In some embodiments of the methods described herein, determining the amount of the cannabinoid in the sample comprises determining the amount based on the absorption of the hemp sample. In some embodiments, determining the amount of the cannabinoid based on the absorption of the hemp sample comprises determining the amount using the following equation: A=∈lc, where A is absorbance, ∈ is a molar extinction coefficient, l is a length of a light path, and c is the concentration of the cannbinoid in the sample.

As indicated above, by making use of the methods of the presently-disclosed subject matter, including the hemp samples and wavelengths of light described herein, it is believed that the present techniques are capable of greatly increasing the efficiency and decreasing cost over time of the assays as compared to the current standard techniques for measuring cannabinoid content and that make use of gas chromatography (GC) or high performance liquid chromatography (HPLC). Moreover, and with regard to the analysis of CBD and its acidic form CBDA, the samples prepared for plate reader measurements do not undergo a heating process that results in the decarboxylation of the acidic cannabinoid and are thus in contrast to preparations for gas-chromatographic analysis. As such, in certain embodiments, the measurements being made by an exemplary plate reader can be comprised of mostly acidic cannabinoids.

The presently-disclosed subject matter is further illustrated by the following specific but non-limiting examples.

### EXAMPLES

Materials and Methods for Examples 1-9

The materials utilized included a BMG LabTech CLARIOstar® Microplate Reader, Corning® Brand 96-Well UV Plates, and GenCanna Global Crystalline Cannabidiol 99% pure.

The protocol for preparing fresh plant hemp samples for GC, HPLC, and the plate reader was as follows (Protocol 1):
1. Separate leaf, bud, and seed
2. Weigh ˜100-150 mg samples place in ˜2 mL polypropylene snap cap or screw cap tubes
3. Add 4 Zirconium beads+one glass bead and cap tightly
4. Submerge tubes into liquid Nitrogen and wait until boiling settles
5. Place immediately into bead beater and run Pine Needle program
6. Repeat steps 3 and 4 two more times
7. Add 0.01 mL 0.05 mg/mL tribenzylamine (TBA) solution per mg sample
8. Sonicate for 15 min at ¾ power (7.5), maximum frequency (1,000 Hz) and bath ½ full of water
9. Centrifuge 5 min. in a centrifuge (20627×g, 4° C.) and use syringe filter (0.45 μm) and transfer all the supernatant, ˜900 μL into HPLC vials
10. Take 600 μL of supernatant and transfer to amber GC vial for GC measurement
11. In one set of vials take 20 μL and transfer to well of non-UV 96 well plate and dilute with 80 μL of ethanol and TBA for a 1:5 dilution
12. Take 20 μL of the solution in step 11 and transfer to the 96 well Corning UV Plate and dilute with 180 μL of ethanol and TBA for a 1:10 dilution
13. Repeat steps 11 and 12 for all samples in duplicate
14. Take an untouched set of samples and put the vials into a heating block (150° C.) for 30 min
15. Cap and reconstitute in 1 mL 100% ethanol
16. Store GC and HPLC vials at −20° C. ready for injection into the GC/FID

The protocol for preparing dry plant hemp samples for GC, HPLC, and plate reader was as follows (Protocol 2):
1. Separate leaf, bud, and seed
2. Weigh˜15 mg samples and place in˜2 mL polypropylene snap cap or screw cap tubes
3. Add 4 Zirconium beads+one glass bead
4. Add 0.1 mL 0.05 mg/mL tribenzylamine (TBA) solution per mg sample and cap tightly
5. Sonicate for 15 min at ¾ power (7.5), maximum frequency (1,000 Hz) and bath ½ full of water
6. Centrifuge 5 min. in a centrifuge (20627×g, 4° C.) and use syringe filter (0.45 μm) and transfer all the supernatant, ˜900 μL into HPLC vials
7. Take 600 μL of supernatant and transfer to amber GC vial for GC measurement
8. In one set of vials take 20 μL and transfer to well of non-UV 96 well plate and dilute with 80 μL of ethanol and TBA for a 1:5 dilution
9. Take 20 μL of the solution in step 11 and transfer to the 96 well Corning UV Plate and dilute with 180 μL of ethanol and TBA for a 1:10 dilution
10. Repeat steps 11 and 12 for all samples in duplicate
11. Take an untouched set of samples and put the vials into a heating block (150° C.) for 30 min
12. Cap and reconstitute in 1 mL 100% ethanol
13. Store GC and HPLC vials at −20° C. ready for injection into the GC/FID

### Example 1

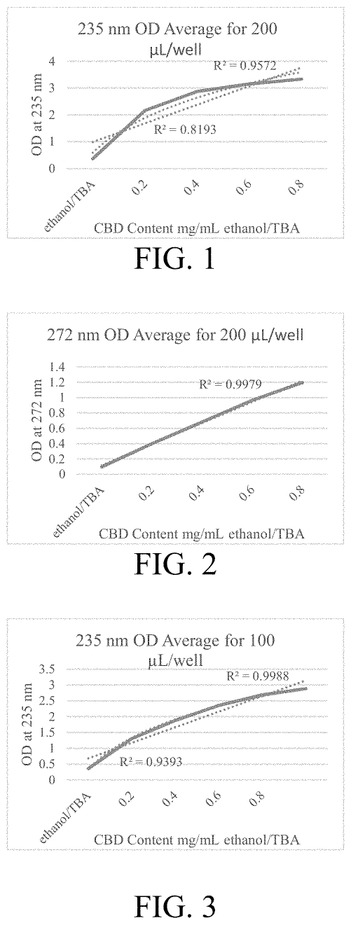

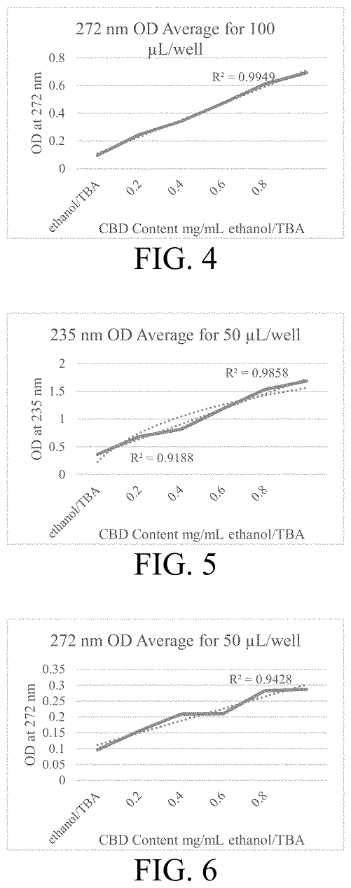

Developing a robust standard curve for the plate reader was important for accurate and precise results when measuring samples. The amount of liquid per well was determined by testing 200 μL, 100 μL, and 50 μL at wavelengths of 235 nm and 272 nm (FIGS. 1-6). The optical density (OD) for 235 nm starts to saturate around 0.3 mg CBD/mL TBA+ethanol. This does not occur at 272 nm as the OD values are on average lower. Logarithmic and linear lines were fit to 235 nm because the OD can only be detected until a certain concentration. Both 200 μL and 100 μL showed excellent correlations for logarithmic fit on 235 nm and linear fit on 272 nm. 50 μL was eliminated as the correlation was slightly lower.

### Example 2

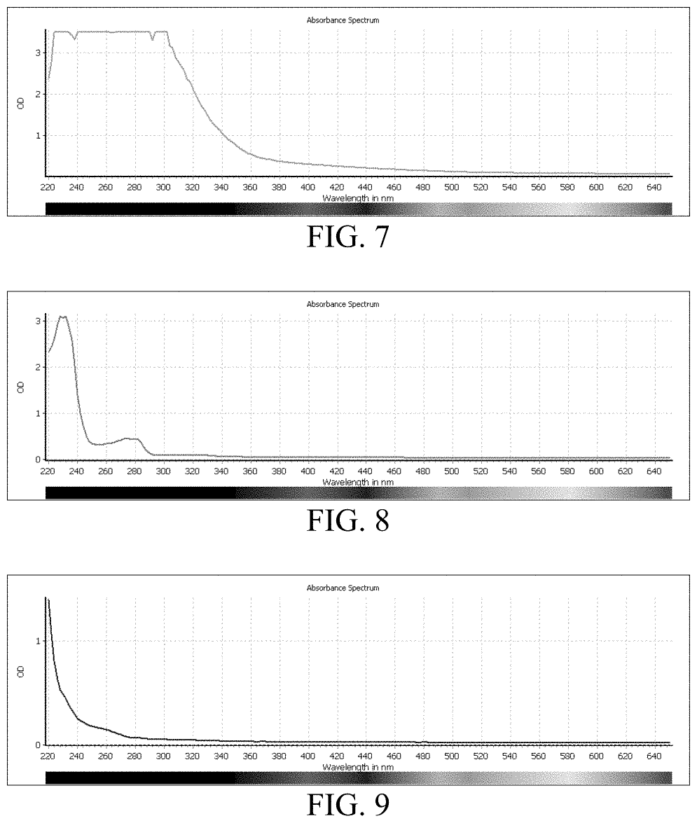

Scans from 220 nm-650 nm at 0.1, 0.2, 0.4, 0.6, 0.8, 1, 1.56, 3.125, 6.25, 10, 12.5, 25, 50, 100, and 200 mg CBD/mL ethanol+TBA were done on the plate reader to find the optimal range of concentrations that would show peaks and valleys without saturating the plate reader. The scans were run in duplicate using 200 μL/well. FIGS. 7-9 show a range of sample scans showing saturated and unsaturated conditions.

### Example 3

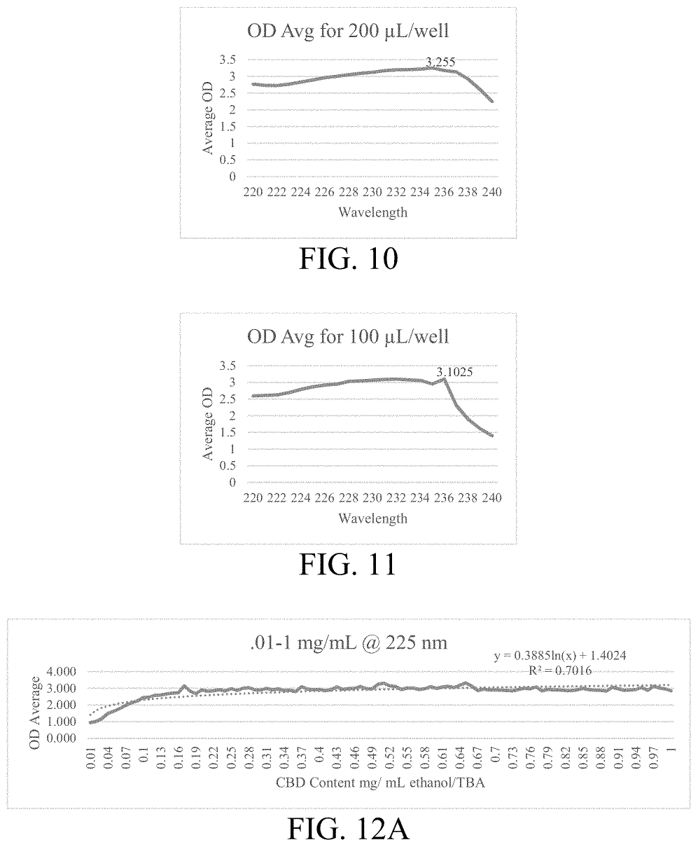

To find the first peak wavelength, a solution of 1 mg CBD/mL ethanol+TBA using 100 and 200 μL/well was measured at wavelengths 220-240 nm in 1 nm increments (FIGS. 10-11). The peak wavelength in this range was determined to be 235 nm for 200 μL/well and 236 for 100 μL/well. Samples are the average of duplicate.

### Example 4

Dilutions from 0.01 -1 mg CBD/mL Ethanol+TBA in 0.01 increments were made in order to narrow the range of optimal concentrations for a linear response in OD versus concentration. These dilutions were measured at four wavelengths 225 nm, 235 nm, 255 nm, and 272 nm using 200 μL/well.

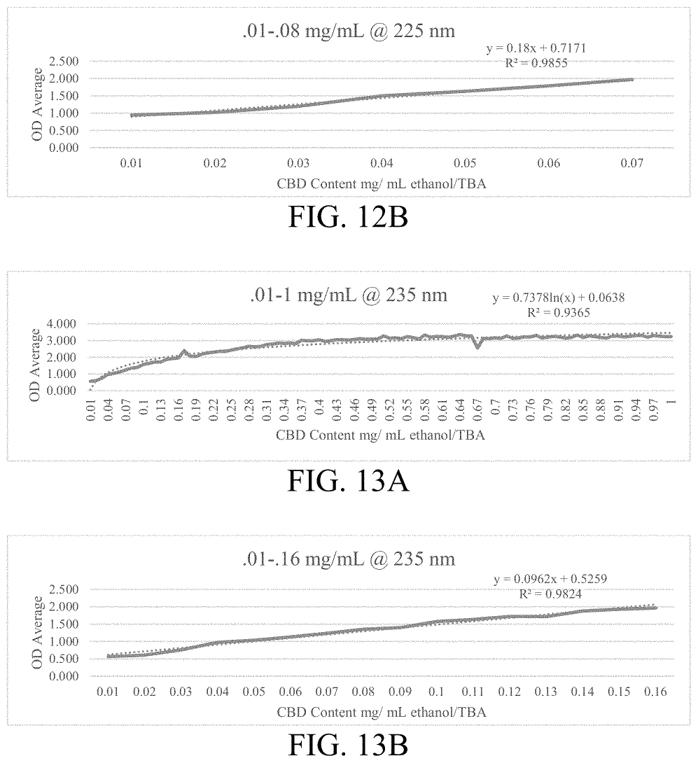

FIGS. 12A-12B and 13A-13B show that 225 nm and 235 nm have higher OD values for higher CBD concentrations. This can also be seen in FIG. 8 where the beginning of the scan has a peak between 220 nm and 240 nm. FIGS. 12 and 13 were fitted with a logarithmic curve because the behavior of the data suggested that around 0.1 mg CBD/mL ethanol+TBA for 225 nm the OD becomes too high and is no longer linear. This point occurred around 0.2 mg CBD/mL ethanol+TBA. These wavelengths were still options for determining CBD, but the concentration of the sample was thought to be a limiting factor and was believed to need to be diluted if the OD reaches above 2. After selecting the OD equal or less than 2, wavelengths of 225 nm and 235 nm have excellent linear correlation equaling 0.9855 and 0.9824 respectively.

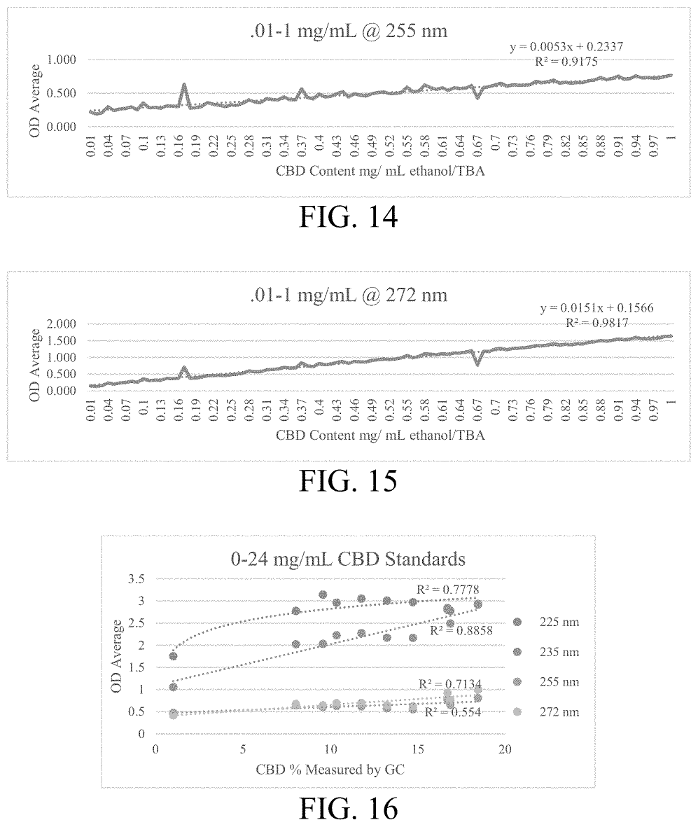

FIGS. 14-15 shows a relatively linear response between OD and CBD concentration, with 272 nm having a higher correlation of 0.9817.

### Example 5

The previous studies involved using CBD standard from GenCanna (Lexington, Ky.) to determine the OD values at certain wavelengths. The following studies examined dried hemp material with varying CBD concentrations and textures. The first set of hemp standards were created by adding CBD back to hemp material that had been processed and depleted of its original CBD. This material was a mix of fibrous and ground textures, and the protocol for this addition was as follows (Protocol 3):
1. Sieve hemp material through 1/14″ screen until material is homogenous
2. Weigh 14 sets of 5 g of material into blue weighing boats and label 1, 2, 3, 4, 5, 6, 7, 8, 12, 14, 16, 18, 22, and 24
3. Weigh 1.2 g of CBD and put into test tube
4. Add 5mL of ethanol to the CBD and stir with glass rod and vortex to ensure all CBD is dissolved
5. Pour solution onto hemp material labeled 24 and mix
6. Repeat steps 4 and 5 for all weights of CBD as Table 1
7. Set all weighing boats in the back of a drawer, slightly cracked for airflow overnight
8. After 24 hours mix well with glass stirring rod and transfer to 50 mL tubes with caps

TABLE 1
Corresponding values for weight of added CBD to % of CBD after addition
to depleted hemp material following the protocol above.

| CBD % | 24 | 22 | 18 | 16 | 14 | 12 | 8 | 7 | 6 | 5 | 4 | 3 | 2 | 1 |
|---|---|---|---|---|---|---|---|---|---|---|---|---|---|---|
| CBD (g) in 5 | 1.2 | 1.1 | 0.9 | 0.8 | 0.7 | 0.6 | 0.4 | 0.35 | 0.3 | 0.25 | 0.2 | 0.15 | 0.1 | 0.05 |
| mL ethanol | | | | | | | | | | | | | | |

These standards were referred to as 0-24 mg/mL CBD Standards and data can be seen in FIG. 16.

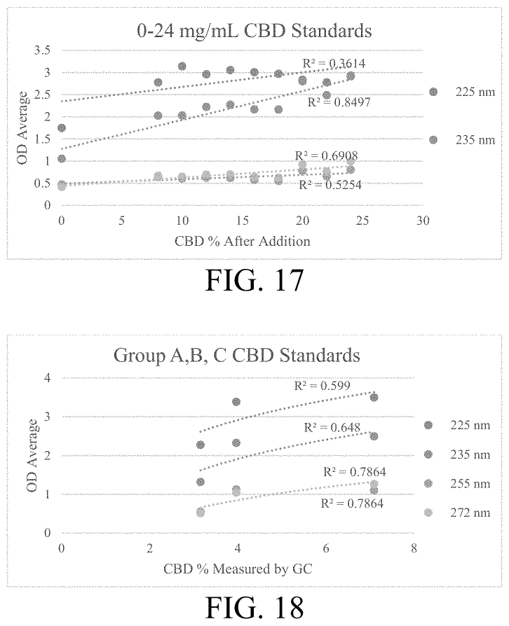

The next set of standards were received from GenCanna and were called Group A, B, C. They included materials that had been taken out of processing for CBD at different times. This material was relatively homogenous with C being visually the most homogenous. C was also the darkest, with the least amount of light fibrous pieces. A had the most fibrous pieces and the lightest color and B was between these. Data can be seen in FIG. 17.

The third set of the standards were also attained from GenCanna called FS1, FS2, FS3, FS4, FS5, FS6, and FS7. These were originally whole, dried, plant but an aliquot was taken and ground to achieved a more homogenous material and then analyzed. Data can be seen in FIG. 18.

For this study, a logarithmic fit curve was most appropriate because the graphs showed a trend of OD leveling off as CBD increased. This was expected and was consistent with the results seen in the past studies. There was clearly a threshold at which the plate reader could not accurately determine the optical density above this point and so it presents the highest possible OD value.

### Example 6

As a continuation of Study 4, more dilutions in the lower concentration range were tested for correlation between OD and CBD content due to the observed OD saturation for the higher concentration samples. Samples that were measured to be above an OD of 2 were diluted 1:2 or 1:5 depending on the wavelength and then their OD was calculated back. This way the microplate reader was able to accurately measure the OD and the sample can have a calculated OD above what the plate reader was able to do, allowing for CBD content versus OD to have a good correlation. The OD at 225 nm and 235 nm was much higher than the OD at 255 nm and 272 nm. This was expected and can be seen in FIGS. 8-9.

Standards included 12 samples with ethanol as the solvent and 0.05 mg/mL of TBA in the ethanol. Concentrations of CBD dissolved into the solvent were: 0 mg/mL, 0.01 mg/mL, 0.02 mg/mL, 0.03 mg.mL, 0.04 mg/mL, 0.05 mg/mL, 0.06 mg/mL, 0.08 mg/mL, 0.1 mg/mL, 0.15 mg/mL, 0.2 mg/mL, and 0.25 mg/mL.

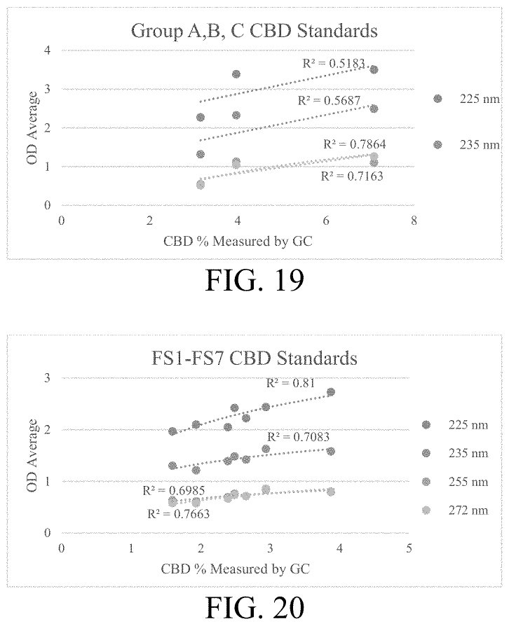

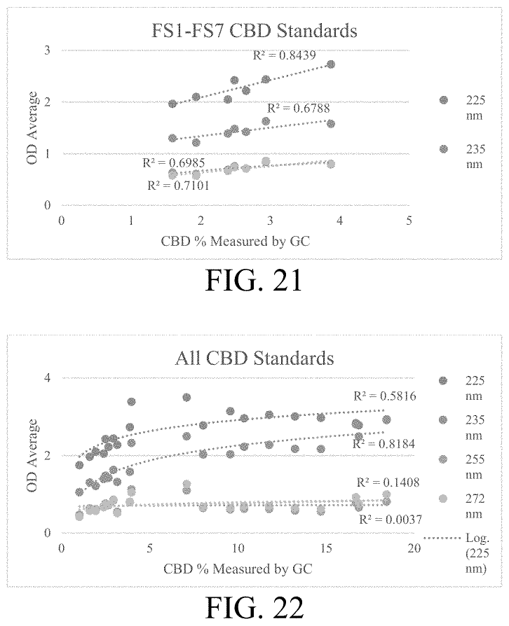

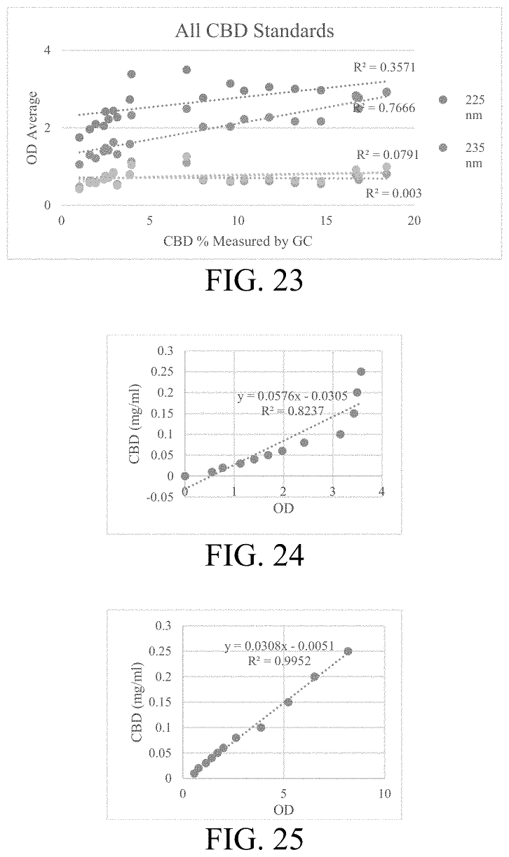

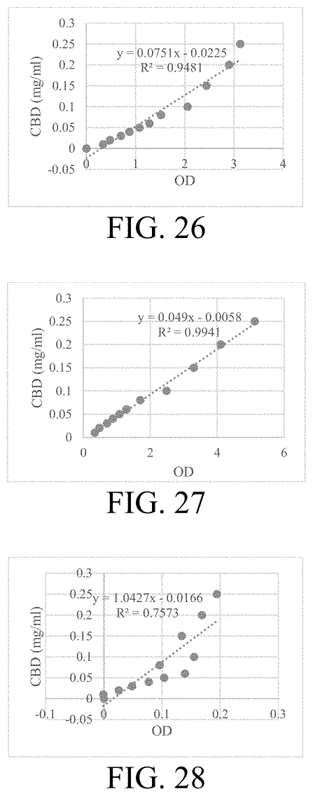

As shown in FIGS. 18-21, it was observed that 255 nm data does not correlate well with the CBD concentration, so it was considered the least out of the four wavelengths. For higher concentrations, OD of the wavelength of 272 nm demonstrated good correlations without further dilutions. Wavelengths of 225 nm and 235 nm show good correlation, especially in a low concentration. Concentrations below 0.08 mg/ml for 225 nm and concentrations below 0.15 mg/ml for 235 nm have high correlation to standard CBD concentration without further dilutions. For 255 nm and 272 nm, the dilution did not have as much of an effect on correlation compared to 225 nm and 235 nm. This was likely because 225 nm and 235 nm have higher OD values. FIG. 23 was used as the standard curve when calculating CBD content for diluted plant samples using OD values from plate reader. The wavelength 225 nm required the most dilution to get OD values in the range that is reliable. This left more room for error and the fewer dilutions that have to make means technical error is less likely.

### Example 7

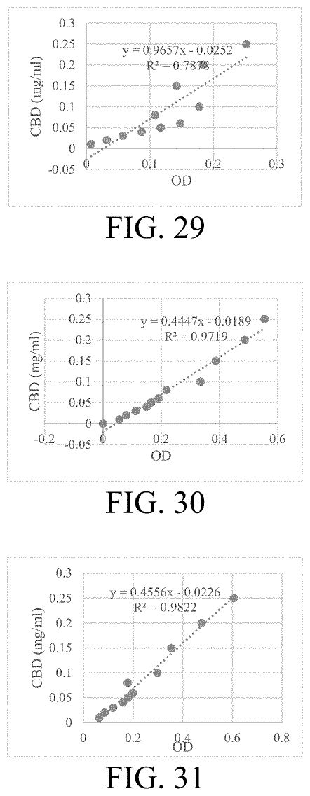

Fresh hemp samples were processed using Protocol 1 and standard curves (FIGS. 25, 27, 29 and 31) for different wavelengths were used to calculate CBD (%) from OD of a plate reader. CBD content from the plate reader at 235 nm was calculated as follows:

$$\begin{matrix}Blank corrected OD = Measured OD - Average OD of blanks ( well + EtOH + 0.05 mg / ml TBA ) & ( Eq . 1 ) \\ Calculated OD = Blank corrected OD * Dilution Factor & ( Eq . 2 ) \\ Fresh Weight ( FW ) CBD concentration ( \frac{mg}{mL} ) = 0.0493 * ( Calculated OD ) - 0.0058 & ( Eq . 3 ) \\ FW CBD concentration ( \% ) = FW CBD concentration ( \frac{mg}{mL} ) * \frac{vol . of solution ( mL )}{wt . of fresh sample ( mg )} * 100 & ( Eq . 4 ) \\ Dry weight CBD Concentration ( \% ) = \frac{FW CBD ( 5 )}{100 - moisture content} * 100 & ( Eq . 5 )\end{matrix}$$

In each plate reader analysis, a blank which was 0.05 mg/ml TBA in EtOH was included and measured. Average value of blanks was subtracted from the OD values of samples to get blank corrected ODs.

TABLE 2
Average OD and standard error of plate well with 0.05
mg/ml TBA in ethanol which is used as a blank and plate
reader well with air in different wavelengths.

| | | Average well + | SE well + | | |
|---|---|---|---|---|---|
| | | EtOH + TBA | EtOH + TBA | Average | SE |
| | | (blank) | (blank) | air + well | air + well |
| 225 | nm | 0.72 | 0.10 | 0.22 | 0.00 |
| 235 | nm | 0.47 | 0.08 | 0.17 | 0.00 |
| 255 | nm | 0.24 | 0.05 | 0.11 | 0.00 |
| 272 | nm | 0.15 | 0.04 | 0.09 | 0.00 |

The moisture content of leaf and bud samples was determined using NIST AO1 protocol and averaged. Bud had more moisture than leaf samples.

TABLE 3
Average moisture content % (w/w) of
leaf and bud using NIST AO1 protocol.

| All samples | Average moisture % | SE |
|---|---|---|
| Leaf | 81.36 | 0.66 |
| Bud | 90.90 | 0.56 |

TABLE 4
Dry weight based CBD (%) of fresh leaf and bud samples calculated from OD values of a plate reader (using
Eq. 1-5) at 225 nm, 235 nm, 255 nm, and 272 nm, and CBD (%) from gas chromatography analysis. R² of
CBD (%) calculated from different wavelengths and GC CBD (%) for fresh samples were determined.

| | | CBD (%) | SE | CBD (%) | SE | CBD (%) | SE | CBD (%) | SE | | |
|---|---|---|---|---|---|---|---|---|---|---|---|
| | Leaf/ | @225 | @225 | @235 | @235 | @255 | @255 | @272 | @272 | GC-CBD | |
| Sample name | Bud | nm | nm | nm | nm | nm | nm | nm | nm | (%) | SE |
| Ben Furnish | Leaf | 7.34 | 0.50 | 8.17 | 0.54 | 103.57 | 6.60 | 50.21 | 2.79 | 2.04 | 0.30 |
| 4-C2-2 | Leaf | 3.38 | 0.11 | 3.64 | 0.12 | 58.81 | 1.64 | 28.30 | 0.70 | 0.50 | 0.00 |
| 18-I12-1 | Leaf | 3.59 | 0.32 | 4.22 | 0.41 | 65.94 | 5.90 | 31.51 | 2.26 | 0.62 | 0.08 |
| Anderson#2 | Leaf | 29.07 | 3.02 | 27.95 | 2.84 | 316.36 | 35.02 | 167.47 | 24.61 | 8.14 | 1.49 |
| Anderson#1 | Leaf | 14.07 | 0.54 | 13.75 | 0.63 | 162.69 | 8.02 | 72.98 | 2.47 | 5.17 | 0.23 |
| Weebs farm | Leaf | 10.79 | 0.70 | 11.34 | 0.73 | 141.18 | 9.23 | 68.63 | 3.95 | 3.26 | 0.31 |
| Anderson#3 | Leaf | 10.16 | 0.95 | 10.02 | 0.83 | 118.99 | 10.49 | 60.52 | 4.09 | 3.76 | 0.68 |
| 3-B3-1 | Leaf | 3.65 | 0.46 | 4.08 | 0.51 | 60.75 | 7.52 | 30.56 | 3.47 | 0.77 | 0.16 |
| 4-B4-13 | Leaf | 4.57 | 0.10 | 5.86 | 0.17 | 91.46 | 2.96 | 39.82 | 0.89 | 0.36 | 0.02 |
| 12-A5-7 | Leaf | 3.17 | 0.43 | 3.58 | 0.50 | 57.06 | 6.25 | 28.19 | 2.18 | 0.89 | 0.22 |
| 7-D8-6 | Leaf | 6.21 | 0.55 | 6.48 | 0.57 | 90.83 | 6.60 | 40.52 | 2.81 | 1.97 | 0.21 |
| Ben Furnish | Bud | 60.92 | 2.42 | 57.99 | 2.64 | 633.15 | 31.87 | 389.48 | 15.17 | 27.49 | 3.62 |
| 4-C2-2 | Bud | 17.16 | 1.32 | 16.29 | 1.41 | 207.90 | 19.99 | 106.98 | 8.01 | 3.23 | 0.08 |
| 18-I12-1 | Bud | 18.75 | 0.83 | 17.94 | 0.96 | 210.16 | 12.00 | 112.99 | 4.75 | 8.41 | 0.50 |
| Anderson#2 | Bud | 75.57 | 3.13 | 70.82 | 3.64 | 805.37 | 50.35 | 525.95 | 37.46 | 23.11 | 2.22 |
| Anderson#1 | Bud | 90.72 | 3.39 | 88.58 | 1.26 | 1025.63 | 14.95 | 648.01 | 10.47 | 34.19 | 4.87 |
| Weebs farm | Bud | 41.57 | 1.56 | 40.50 | 1.45 | 427.49 | 22.48 | 252.90 | 11.35 | 15.17 | 0.87 |
| Anderson#3 | Bud | 72.43 | 1.21 | 68.04 | 1.08 | 743.81 | 17.14 | 422.91 | 8.02 | 28.52 | 4.74 |
| 3-B3-1 | Bud | 14.55 | 1.27 | 14.11 | 1.39 | 163.45 | 17.40 | 87.74 | 7.55 | 6.41 | 0.64 |
| 4-B4-13 | Bud | 15.01 | 0.87 | 15.52 | 1.13 | 187.47 | 16.00 | 98.84 | 5.70 | 5.49 | 0.01 |
| 12-A5-7 | Bud | 15.64 | 1.78 | 14.82 | 1.53 | 169.56 | 12.03 | 91.83 | 8.56 | 7.66 | 0.22 |
| 7-D8-6 | Bud | 40.72 | 3.00 | 39.59 | 2.71 | 429.62 | 36.05 | 240.00 | 15.59 | 15.59 | 0.59 |
| 13-G14-3 | Bud | 4.36 | 0.95 | 5.31 | 1.25 | 79.67 | 21.20 | 33.46 | 8.20 | 6.67 | 0.49 |
| 14-G14-11 | Bud | 19.18 | 3.54 | 18.35 | 3.16 | 209.63 | 38.06 | 89.39 | 12.33 | 10.55 | 1.31 |
| 14-G14-11 | Leaf | 3.72 | 0.55 | 4.36 | 0.69 | 68.59 | 8.92 | 30.32 | 3.23 | 0.96 | 0.08 |
| 13-G14-11 | Leaf | 3.53 | 0.17 | 4.17 | 0.25 | 61.86 | 4.35 | 26.83 | 1.60 | 0.78 | 0.02 |
| 14-G14-3 | Leaf | 2.56 | 0.46 | 3.36 | 0.56 | 50.65 | 8.27 | 21.76 | 2.64 | 0.51 | 0.03 |
| 13-G14-11 | Bud | 15.88 | 1.89 | 15.46 | 1.68 | 177.78 | 19.83 | 82.51 | 8.55 | 6.24 | 0.67 |
| 14-G14-3 | Bud | 31.03 | 0.82 | 28.22 | 0.83 | 329.17 | 10.73 | 150.24 | 6.81 | 13.60 | 1.46 |
| R2 | | 0.95 | | 0.95 | | 0.94 | | 0.91 | | | |

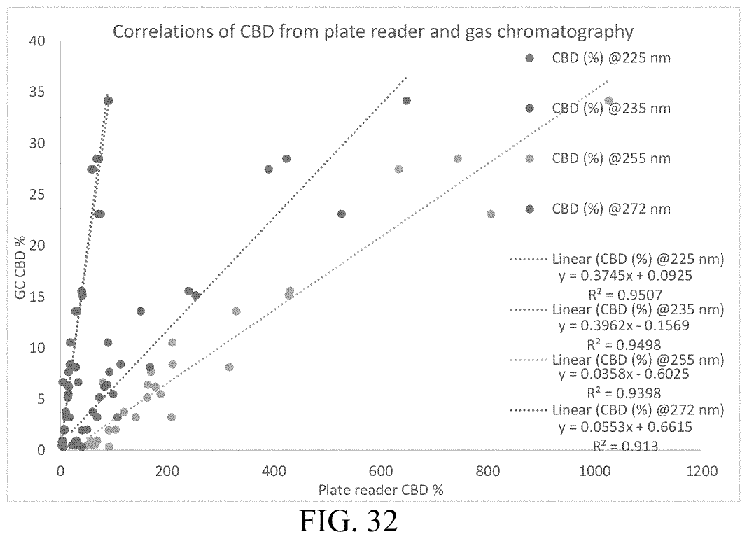

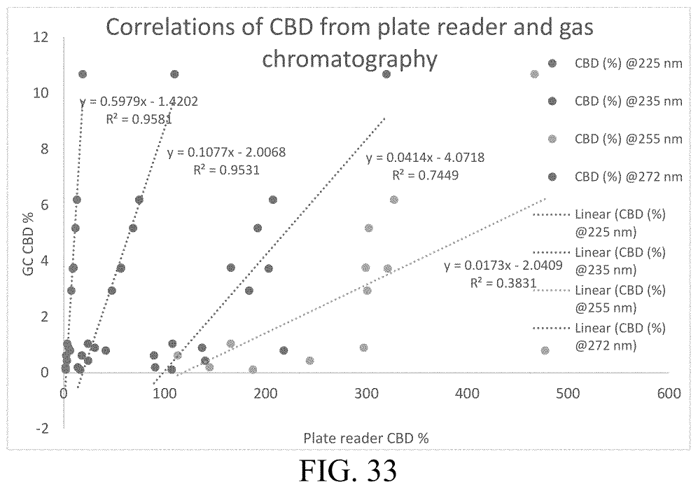

Table 4 shows a high R² (>0.91) between plate reader and GC data for all wavelengths. FIG. 32 is a graphical representation of the values in Table 4. The plate reader CBD % values appear to be unusually high but on further inquiry this was because the wavelengths chosen to determine CBD content, 235 nm, that has the highest correlation is not only measuring CBD. The standards were created with only CBD dissolved in ethanol with TBA. Actual hemp plant samples contained many more molecules than this and many of these likely had some absorbance at 235 nm. This skewed the values from the plate reader to seem like they are abnormally high, but this was because it accounts for other molecules. This data correlated well with data from GC. Using this calibration curve, it was possible to determine the CBD concentration with the plate reader, especially ones with high CBD concentrations. Calculating CBD content from a blank with only ethanol and TBA was not representative of the baseline for hemp plant samples. A fresh hemp sample with little to no CBD content should be implemented as the blank to calculate the OD in order to eliminate the interference from other molecules.

### Example 8

Dry hemp samples were processed using Protocol 2 and standard curves (FIGS. 25, 27, 29 and 31) for different wavelengths were used to calculate CBD (%) from OD of a plate reader. CBD content from the plate reader was calculated using Eq. 1-4 in Example 7. Since samples were dried already, it was not necessary to further convert to dry weight CBD (%) as in Eq. 5.

In Table 5, a high correlation of CBD (%) was observed between dry and fresh samples in plate reader measurement of 225 nm and 235 nm, and GC measurement. Furthermore, high R² (>0.95) of CBD (%) obtained from plate reader at 225 nm and 235 nm, and GC data for dry samples was noticed. Unlike the fresh samples in Example 7, CBD (%) of 255 nm and 272 nm didn't correlate well with CBD (%) from GC. Similarly to Example 7, plate reader CBD (%) values are higher than CBD values of GC measurement.

TABLE 5
Dry weight based CBD (%) of fresh and dry leaf and bud samples calculated from OD values of a plate reader (using Eq. 1-5)
at 225 nm, 235 nm, 255 nm, and 272 nm, and CBD (%) from gas chromatography analysis. The correlation coefficient of dry and fresh
samples and R² of CBD (%) calculated from different wavelengths and GC CBD (%) for dry samples were determined.

| | | | CBD (%) | SE | CBD (%) | SE | CBD (%) | SE | CBD (%) | SE | | |
|---|---|---|---|---|---|---|---|---|---|---|---|---|
| | Leaf/ | Fresh/ | @225 | @225 | @235 | @235 | @255 | @255 | @272 | @272 | CBD | |
| Sample name | Bud | Dry | nm | nm | nm | nm | nm | nm | nm | nm | (%) | SE |
| Ben Furnish | Leaf | Fresh | 7.34 | 0.50 | 8.17 | 0.54 | 103.57 | 6.60 | 50.21 | 2.79 | 2.04 | 0.30 |
| Anderson#2 | Leaf | Fresh | 29.07 | 3.02 | 27.95 | 2.84 | 316.36 | 35.02 | 167.47 | 24.61 | 8.14 | 1.49 |
| Anderson#1 | Leaf | Fresh | 14.07 | 0.54 | 13.75 | 0.63 | 162.69 | 8.02 | 72.98 | 2.47 | 5.17 | 0.23 |
| Weebs farm | Leaf | Fresh | 10.79 | 0.70 | 11.34 | 0.73 | 141.18 | 9.23 | 68.63 | 3.95 | 3.26 | 0.31 |
| Anderson#3 | Leaf | Fresh | 10.16 | 0.95 | 10.02 | 0.83 | 118.99 | 10.49 | 60.52 | 4.09 | 3.76 | 0.68 |
| 3-B3-1 | Leaf | Fresh | 3.65 | 0.46 | 4.08 | 0.51 | 60.75 | 7.52 | 30.56 | 3.47 | 0.77 | 0.16 |
| 12-A5-7 | Leaf | Fresh | 3.17 | 0.43 | 3.58 | 0.50 | 57.06 | 6.25 | 28.19 | 2.18 | 0.89 | 0.22 |
| Ben Furnish | Bud | Fresh | 60.92 | 2.42 | 57.99 | 2.64 | 633.15 | 31.87 | 389.48 | 15.17 | 27.49 | 3.62 |
| Anderson#1 | Bud | Fresh | 90.72 | 3.39 | 88.58 | 1.26 | 1025.63 | 14.95 | 648.01 | 10.47 | 34.19 | 4.87 |
| Weebs farm | Bud | Fresh | 41.57 | 1.56 | 40.50 | 1.45 | 427.49 | 22.48 | 252.90 | 11.35 | 15.17 | 0.87 |
| Anderson#3 | Bud | Fresh | 72.43 | 1.21 | 68.04 | 1.08 | 743.81 | 17.14 | 422.91 | 8.02 | 28.52 | 4.74 |
| 3-B3-1 | Bud | Fresh | 14.55 | 1.27 | 14.11 | 1.39 | 163.45 | 17.40 | 87.74 | 7.55 | 6.41 | 0.64 |
| 12-A5-7 | Bud | Fresh | 15.64 | 1.78 | 14.82 | 1.53 | 169.56 | 12.03 | 91.83 | 8.56 | 7.66 | 0.22 |
| Ben Furnish | Leaf | Dry | 4.70 | 0.30 | 30.58 | 1.53 | 297.27 | 14.03 | 137.07 | 4.37 | 0.89 | 0.03 |
| Anderson#2 | Leaf | Dry | 8.93 | 0.90 | 56.43 | 5.22 | 321.07 | 27.85 | 203.08 | 16.07 | 3.73 | 0.44 |
| Anderson#1 | Leaf | Dry | 7.38 | 1.61 | 47.60 | 9.14 | 300.87 | 38.88 | 183.68 | 25.50 | 2.94 | 1.15 |
| Weebs farm | Leaf | Dry | 6.12 | 0.24 | 41.62 | 1.54 | 477.02 | 25.28 | 218.06 | 9.88 | 0.80 | 0.25 |
| Anderson#3 | Leaf | Dry | 3.10 | 0.44 | 24.13 | 2.46 | 243.83 | 21.84 | 140.13 | 8.47 | 0.43 | 0.04 |
| 3-B3-1 | Leaf | Dry | 1.59 | 0.49 | 13.91 | 2.74 | 144.39 | 22.42 | 90.47 | 9.53 | 0.19 | 0.02 |
| 12-A5-7 | Leaf | Dry | 1.86 | 0.34 | 16.12 | 1.92 | 187.47 | 13.94 | 106.97 | 6.05 | 0.12 | 0.01 |
| Ben Furnish | Bud | Dry | 12.89 | 1.07 | 74.77 | 6.11 | 327.39 | 33.89 | 207.21 | 17.83 | 6.19 | 0.65 |
| Anderson#1 | Bud | Dry | 18.61 | 2.28 | 109.71 | 12.57 | 466.66 | 45.75 | 319.98 | 29.50 | 10.68 | 2.45 |
| Weebs farm | Bud | Dry | 9.58 | 0.46 | 56.73 | 3.20 | 299.21 | 33.78 | 165.65 | 17.18 | 3.76 | 0.26 |
| Anderson#3 | Bud | Dry | 11.51 | 0.86 | 68.57 | 4.88 | 302.45 | 25.45 | 192.23 | 14.46 | 5.18 | 0.36 |
| 3-B3-1 | Bud | Dry | 2.39 | 0.24 | 17.84 | 1.42 | 112.84 | 14.55 | 89.38 | 5.15 | 0.62 | 0.08 |
| 12-A5-7 | Bud | Dry | 3.40 | 0.43 | 23.86 | 2.26 | 165.45 | 6.03 | 107.73 | 6.76 | 1.04 | 0.11 |
| Correlation | | | 0.94 | | 0.93 | | 0.56 | | 0.79 | | 0.93 | |
| between dry and | | | | | | | | | | | | |
| fresh | | | | | | | | | | | | |
| R² of plate reader | | | 0.96 | | 0.95 | | 0.38 | | 0.74 | | | |
| and GC for dry | | | | | | | | | | | | |
| samples | | | | | | | | | | | | |

### Example 9

Beer's molar extinction coefficient (∈). Beer-Lambert law describes the linear relationship between the light absorbance and concentration of the material which the light is passing through.

A=∈lc ->∈=A/(lc)

A=absorbance (unitless) ∈=molar extinction coefficient (L mol-1 cm-1 ) l=light path length (cm) c=concentration (mol/L)

For the spectrophotometer path length =1 cm and for the plate reader 1=0.588 cm calculated from the volume in the well. In this regard, using the equation above, it was believed that if a determine ∈ of CBD was made, it was possible to estimate the concentration of CBD of samples from the absorbance. An analysis was thus undertaken to determine the molar extinction coefficient of CBD with different wavelengths and concentrations (Table 7). The coefficient was averaged from different coefficient values of different concentrations and compared to different wavelengths (Table 8). It was observed that coefficients were relatively consistent within different concentrations in the same data measurement and differ significantly between different wavelengths.

TABLE 6
ε of different concentrations of CBD standards at
different wavelengths calculated from the absorbance measured
by spectrophotometer and plate reader (different dates).

| | Concen- | | | | |
|---|---|---|---|---|---|
| | tration | ϵ at | ϵ at | ϵ at | ϵ at |
| | (mg/ml) | 225 nm | 235 nm | 255 nm | 272 nm |
| From the | 0.10 | 9,295 | 7,573 | 578 | 1,185 |
| spectrophotometer | 0.05 | 12,864 | 7,752 | 454 | 1,130 |
| | 0.02 | 12,815 | 7,345 | 178 | 1,016 |
| | 0.01 | 15,922 | 9,638 | 2,147 | 2,557 |
| From plate reader | 0.20 | 5,388 | 3,827 | 185 | 487 |
| 181004 | 0.10 | 5,771 | 3,610 | 107 | 337 |
| | 0.05 | 7,348 | 4,631 | 267 | 353 |
| | 0.02 | 5,535 | 3,423 | 53 | −374 |
| From plate reader | 0.10 | 8,501 | 5,268 | 396 | 797 |
| 181001 | 0.05 | 9,225 | 5,813 | 342 | 722 |
| | 0.02 | 9,372 | 6,137 | 428 | 709 |
| From plate reader | 0.25 | 17,392 | 10,892 | 50,343 | 1,259 |
| 181010 | 0.2 | 17,274 | 10,883 | 45,102 | 1,232 |
| | 0.15 | 18,528 | 11,653 | 44,448 | 1,200 |
| | 0.08 | 17,426 | 10,132 | 58,828 | 1,047 |
| | 0.06 | 17,598 | 11,406 | 124,193 | 1,708 |
| | 0.05 | 18,012 | 11,502 | 110,882 | 1,768 |
| | 0.04 | 18,749 | 11,708 | 102,950 | 2,006 |
| | 0.03 | 19,990 | 12,491 | 86,163 | 2,003 |
| | 0.02 | 20,385 | 12,782 | 68,633 | 2,139 |
| | 0.01 | 29,307 | 17,969 | −5,348 | 2,995 |

TABLE 7
Averaged molar extinction coefficients and SE from different concentrations
of CBD standards at different wavelengths calculated from the absorbance
measured by spectrophotometer and plate reader (different dates).

| | | Spectrophotometer | | 181004 | plate | 181001 | plate | 181010 | plate |
|---|---|---|---|---|---|---|---|---|---|
| | | ∈ (L mol−1 | | ∈ (L mol−1 | reader | ∈ (L mol−1 | reader | ∈ (L mol−1 | reader |
| Wavelength | | cm−1) | SE | cm−1) | SE | cm−1) | SE | cm−1) | SE |
| 225 | nm | 12,724 | 1,354 | 6,011 | 453 | 9,033 | 269 | 19,557 | 1,041 |
| 235 | nm | 8,077 | 527 | 3,873 | 266 | 5,739 | 254 | 12,142 | 659 |
| 272 | nm | 1,472 | 363 | 201 | 195 | 742 | 27 | 1,712 | 171 |

It was expected that the molar extinction coefficient would vary significantly between wavelengths. However, ∈ should not vary as much between different data measurements for the same wavelength. This means that using ∈ for calculations of CBD concentration was not reliable with the limitations of the plate reader. To use the ∈ E value reliably, the CBD concentration needed to be low enough for the plate reader to measure its OD below 2. This occurred for the samples measured above around 0.08 mg CBD/mL ethanol+TBA shown in FIG. 22. This means that to accurately and precisely determine CBD concentration of unknown values, there would be an iterative process when the CBD is too concentrated for the plate reader to measure. The variation between measurements of the same sample at the same wavelength, but at different times causes concern for precision, the closeness of two measurements to each other.

Discussion

There is a growing interest for production of Cannabis sativa including industrial hemp for production of cannabinoids such as cannabidiol (CBD). Example 3 showed that at a wavelength of 235 nm there was a maximum absorption for pure CBD in ethanol with TBA. This was a wavelength not previously mentioned in the literature for measurement of CBD. This wavelength was also one of the best in regards to correlation with actual CBD amounts.

Example 5 was believed to be the first study to demonstrate cannabinoid quantification from crude plant extracts and the validity of this data from the plate reader. This material is ground hemp that has been depleted of cannabinoids through an industrial process, sieved for homogeneity and CBD reintroduced in known amounts. This presented an opportunity to look at different levels of CBD with the potential background that real plant samples may give. As expected, the correlation was not as promising as pure CBD, but still a good correlation was present. This was also done for a sample set of dried, ground, whole green hemp leaf samples, called FS1-7, that had a moderate range of CBD concentrations found by GC analysis. This was done again with samples called A, B, and C which varied by the amount of time they spent in an industrial process and their CBD content. The results for these three sample sets were separated because of the significant difference in material type. The results for these three sample sets demonstrate crude whole hemp extracts can be used for quantitative CBD measurements in a plate reader.

Example 7 shows data directly comparing GC and plate reader measurements. Based on the standard curve, created from the CBD standards, the amount of CBD in hemp samples was calculated. These numbers were disproportionately high compared to the data from GC likely because of the many other molecules in hemp creating a background and a higher OD. However, the correlation between GC data and plate reader data was linear suggesting that the plate reader is not only measuring background, but also cannabinoid content. Specifically, OD values at wavelengths 225 nm and 235 nm correlated well with GC data for both fresh and dry samples. It was in accordance with other who mention that pure CBDA and THCA have absorption maxima at 225 nm and 270 nm while CBCA has an absorption maximum at 255 nm. The wavelength of 235 nm has not been used to correlate to cannabinoid compounds previously. Since absorbance at 225 nm reaches the saturation more readily than at 235 nm, it was more advantageous to use the 235 nm wavelength as it could measure higher concentrations of CBD without further dilution. The plate reader can be used as a supplemental protocol to GC and HPLC data. It is recommended for rapid analysis of CBD/A/cannabinoid levels in plate readers that ethanol extracts be diluted to 0.1 to 2 ODs and data reported at 235 and 272 nm with calculations be made from the 235 nm data. 272 nm data can help with ranking high CBD/A samples without further dilution.

Near infrared spectroscopy (NIRS) calibrations have been developed for quantifying cannabinoids; in prior studies, it is specified that the samples must be dried and ground before measurements are taken and only one sample can be measured at a time. This technique allowed samples to be taken both fresh and dried, as long as the moisture content was measured for fresh samples, and gave a close estimate to the actual content of cannabinoid. Taking fresh samples means less time for drying. The samples used for plate reader measurements can also be ground before preparation as an extract to achieve a more homogenous material. Similar to recent patents and a patent application, which used spectral devices to measure and correlate to cannabinoids, the foregoing studies aimed to measure hemp samples much more rapidly. Moreover, the studies achieved the ability to measure 96 samples simutaneously using a plate reader which enhances the efficiency and speed of cannabinoid measurements. Ultimately, this plate reader protocol provided a method for quantifying cannabinoids such as CBD levels from hemp samples processed in different ways (ie.-dried, ground, intact, and fresh) for multiple samples simutaneously in 96, 384 and even 1,536 well plates in plate readers which are common in modern chemistry and biochemistry labs.

Cannabinoids could also be quantified by fluorescence including using plate readers. This was still a viable option if excitation and emission wavelengths were in the range of the instrument. Data from fluorescence may provide more accurate and precise results that align more closely to GC data. As Leiber et al. (2017) discusses, fluorescence measurements have a high specificity and therefore can be very sensitive and selective.

In summary, the foregoing studies demonstrated that CBD/A/cannabinoid levels of crude Cannabis plant extracts can readily be determined in plate readers with multiwell plates. CBD/A/cannabinoid levels can be quantified at 225, 255 and 272 nm and works best at 235 nm. Use of 96, 384 and 1,536 well plates with automated sample handling would greatly improve sample thruput.

All publications, patents, and patent applications mentioned in this specification are herein incorporated by reference to the same extent as if each individual publication, patent, or patent application was specifically and individually indicated to be incorporated by reference, including the references set forth in the following list:

### REFERENCES

Dionyssiou-Asteriou, A., and Miras, C. (1975). Fluorescence of cannabinoids. Journal of Pharmacy and Pharmacology 27, 135-137.
Gordon, M. J., Jones, L. C., and Lynn, M. S. (2017). Method for target substance detection and measurement. U.S. Pat. No. 9,709,582.
Hazekamp, A. (2007) Cannabis; extracting the medicine. Proefschrift Universiteit Leiden.
Hazekamp, A., Peltenburg, A., Verpoorte, R., and Giroud, C. (2005). Chromatographic and spectroscopic data of cannabinoids from Cannabis sativa L. Journal of liquid chromatography & related technologies 28, 2361-2382.
Kelly, T. (2012). Clarke's analysis of drugs and poisons (Taylor & Francis).
Lieber, C. A., Kruep, R. J., and Makowski, A. J. (2017). Method and Apparatus for Nondestructive Quantification of Cannabinoids. U.S. patent application Ser. No. 14,824,017.
Pierce III, W. B., and Pierce, J. D. (2017). System and method for analysis of cannabis. U.S. Pat. No. 9,546,960.
Sánchez-Carnerero Callado, C., Núñez-Sánchez, N., Casano, S., and Ferreiro-Vera, C. (2018). The potential of near infrared spectroscopy to estimate the content of cannabinoids in Cannabis sativa L.: A comparative study. Talanta 190, 147-157.
Zirpel, B., Kayser, 0., and Stehle, F. (2018). Elucidation of structure-function relationship of THCA and CBDA synthase from Cannabis sativa L. Journal of biotechnology 284, 17-26.
United States Patent Application Publication No. 2020/0300845, published Sep. 24, 2020, and entitled “Methods and Devices for Detection of THC.”

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A method for determining cannabinoid content in a hemp sample, comprising:
providing a hemp sample including an amount of a cannabinoid;
transmitting an amount of light through the hemp sample, the light having a wavelength of 225 nm or 235 nm;
identifying an optical density and/or an absorbance for the hemp sample; and
determining an amount of a cannabinoid in the sample based on the optical density and/or absorbance.

2. The method of claim 1, wherein the hemp sample is a dry hemp sample or a wet hemp sample.

3. The method of claim 1, wherein the hemp sample is an intact hemp sample or a ground hemp sample.

4. The method of claim 1, wherein determining the amount of the cannabinoid in the sample comprises determining the amount based on the optical density of the hemp sample.

5. The method of claim 4, wherein determining the amount of the cannabinoid comprises determining the amount using the following equations 1-5:
$$\begin{matrix}Blank corrected OD = Measured OD - Average OD of blanks ( well + EtOH + 0.05 mg / ml TBA ) & ( Eq . 1 ) \\ Calculated OD = Blank corrected OD * Dilution Factor & ( Eq . 2 ) \\ Fresh Weight ( FW ) CBD concentration ( \frac{mg}{mL} ) = 0.0493 * ( Calculated OD ) - 0.0058 & ( Eq . 3 ) \\ FW CBD concentration ( \% ) = FW CBD concentration ( \frac{mg}{mL} ) * \frac{vol . of solution ( mL )}{wt . of fresh sample ( mg )} * 100 & ( Eq . 4 ) \\ Dry weight CBD Concentration ( \% ) = \frac{FW CBD ( 5 )}{100 - moisture content} * 100 & ( Eq . 5 )\end{matrix}$$

6. The method of claim 1, wherein determining the amount of the cannabinoid in the sample comprises determining the amount based on the absorption of the hemp sample.

7. The method of claim 6, wherein determining the amount of the cannabinoid comprises determining the amount using the following equation: A=∈lc, where A is absorbance, E is a molar extinction coefficient, l is a length of a light path, and c is the concentration of the cannbinoid in the sample.

8. The method of claim 1, wherein the wavelength of the light is 235 nm.

9. The method of claim 1, wherein the wavelength of the light is 225 nm.

10. The method of claim 1, wherein the optical density or absoprtion is measured using a microplate photometer.

11. The method of claim 1, wherein the hemp sample is diluted in a solvent.

12. The method of claim 1, wherein determining the amount of the cannabinoid in the sample based on the identified optical density and/or absorbance comprises comparing the identified optical density and/or absorbance to a control amount.
